(19) United States
(12) Patent Application Publication
(10) Pub. No.: US 2024/0339030 A1
(43) Pub. Date: Oct. 10, 2024

(54) COMPUTER-IMPLEMENTED METHOD AND SYSTEM FOR PREDICTING TRAJECTORIES OF PARTICIPANTS IN A TRAFFIC SCENE

(71) Applicant: Robert Bosch GmbH, Stuttgart (DE)

(72) Inventor: Marcel Hallgarten, Ehningen (DE)

(21) Appl. No.: 18/598,053

(22) Filed: Mar. 7, 2024

(30) Foreign Application Priority Data
Apr. 4, 2023 (DE) 10 2023 203 109.4

(51) Int. Cl. G08G 1/01

(52) U.S. Cl. CPC G08G 1/0137; G08G 1/0125

(57) ABSTRACT

A computer-implemented method for predicting at least one trajectory of at least one participant of a traffic scene. A scene representation of the traffic scene is generated on the basis of aggregated scene-specific information, and at least one trajectory for the at least one participant is predicted on the basis of the scene representation using a pretrained AI prediction model. A current position of the participant and a current track section on which the participant is currently located are determined. The scene representation is then transformed into at least one Frenet coordinate system, wherein the current track section specifies at least one section of the respective reference path for the Frenet transformation. The prediction is based on the at least one resulting Frenet representation of the traffic scene.

### CROSS REFERENCE

The present application claims the benefit under 35 U.S.C. § 119 of German Patent Application No. DE 10 2023 203 109.4 filed on Apr. 4, 2023, which is expressly incorporated herein by reference in its entirety.

### FIELD

The present invention relates to a computer-implemented method and system for predicting trajectories of participants in a traffic scene. This involves first aggregating and processing scene-specific information to create a scene representation of the traffic scene. The actual prediction is carried out using an artificial intelligence-based AI prediction model, which uses the scene representation to predict potential future trajectories for one or more traffic scene participants.

A preferred field of application of the present invention is autonomous driving. Other applications are possible too, however; for example in the context of infrastructure-based traffic control systems or in the field of robotics.

### BACKGROUND INFORMATION

The task of autonomous driving is to control an ego vehicle solely on the basis of sensor data, such as radar, LiDAR and RGB camera, as well as other aggregated traffic scene-specific information, such as map information, traffic situation information, weather and road condition information, in such a way that a destination is reached as quickly, comfortably and safely as possible. The ego vehicle should comply with all traffic rules as far as possible and not cause any collisions with other traffic participants or objects. This task can be divided into the subtasks perception, prediction, planning and control.

The task of perception is to extract “relevant” information from the abundance of aggregated sensor data and other scene-specific information. This includes object recognition as well as determining the position and the state of motion of the identified objects or participants. Classifying the identified objects, for example into static and dynamic objects, into infrastructure elements and traffic participants, into vehicles and pedestrians, etc., is relevant as well. A scene representation of the traffic scene is generated on the basis of the extracted relevant information. The task of prediction is to predict or estimate the future positions, i.e., the trajectories, of dynamic objects in the traffic scene based on the scene representation. The results of the prediction are used in planning to ascertain a targeted trajectory for the ego vehicle that is as safe as possible. The task of control is then to implement or set this trajectory by appropriately controlling the vehicle actuators.

The prediction typically predicts the future behavior of each identified and observed participant of the traffic scene individually. Based on contextual information from the scene representation, at least one trajectory that the observed participant is expected to follow is predicted. In addition to map information, the contextual information usually also includes information about the past development of the traffic scene, such as positions and states of other traffic participants and infrastructure collected over a past observation horizon. Since the objective of the observed participants is inherently unknown, however, it is usually not sufficient to predict a single behavior, i.e., a single trajectory. Instead, a set number, usually 6-10, of potential future trajectories is predicted for a participant.

The use of AI-based prediction models for a prediction is conventional. The contextual information of the scene representation is typically depicted in a Cartesian coordinate system, the origin of which is the midpoint of the rear axle or the center of gravity of the observed vehicle. The predicted trajectories of the participants are also typically depicted in this local coordinate system.

Depicting a single trajectory of a traffic participant in a Frenet coordinate system is conventional as well. The position is depicted as a path along a reference line and as a deviation transverse to said reference line. The reference line of a Frenet coordinate system is hereinafter also referred to as the reference path.

### SUMMARY

According to an example embodiment of the present invention, measures that enable the use of Frenet representations in connection with an AI-based prediction model are provided. The prediction method according to the present invention benefits from the advantages of Frenet transformation and at the same time can use the latest and most accurate AI prediction models, because no special modeling of individual contextual information of the scene representation is required.

According to an example embodiment of the present invention, this is achieved by first determining a current position of the participant for whom trajectories are to be predicted. The current position of the participant can be determined by evaluating sensor data, for instance. A current track section on which the participant is currently located is determined as well. If the participant is a vehicle, a track section refers here to a section of a travel lane or roadway, for example. In the case of a pedestrian, a track section could also refer to a section of a footpath, such as a crosswalk. A track section will in any case routinely be shown in a map of the traffic scene recorded as a drivable or walkable section of the route. The determination of the current track section can also be determined independently of the position determination on the basis of sensor data. However, the current track section can also be determined simply by assigning the current position to corresponding map information.

According to an example embodiment of the present invention, the entire scene representation is transformed into at least one Frenet coordinate system. At least one section of the reference path required for the respective Frenet transformation is specified by the current track section. The centerline or a lateral boundary line of the current track section, for example, could be used as the section of the reference path of the Frenet transformation. The resulting Frenet representation of the entire traffic scene with all contextual information is then used as the basis for the AI-based prediction. According to the present invention, the Frenet representation of the traffic scene therefore forms the input for an AI prediction model that is pretrained for this purpose.

Transforming the contextual information into a Frenet coordinate system according to the present invention makes it possible to achieve a decomposition in longitudinal and transverse movement along a track. This can significantly increase the robustness and generalization ability of prediction models. Transforming the entire scene or scene representation makes it possible to use existing AI prediction models without any additional model changes.

In a preferred embodiment of the method according to the present invention, at least one track sequence is determined for the participant in addition to the current position and the current track section. A track sequence always includes the current track section and also a possible continuation of the current track section, i.e., a path that can be traveled starting from the current position and the current track section. However, the different track sequences can be used not only to describe different route options for the participant, but also different driving maneuvers, such as “driving in a lane” or “passing maneuver with lane change”. A specific route or behavior option of the participant is then taken into account in the prediction in that the corresponding track sequence specifies the reference path for the Frenet transformation of the scene representation. As already mentioned, the centerline of the track sequence can be used as the reference path, for example.

This approach also makes it possible to easily take multiple different route and behavior options for the participant into account in the prediction by creating a separate Frenet transformation of the scene representation for each one of the respective track sequences. For each of these Frenet transformations, a separate reference path specified by the respective track sequence is used. It is particularly advantageous that the same pretrained AI prediction model can be used for all resulting Frenet representations of the traffic scene to predict trajectories for the participant.

This advantageously involves the use of an AI prediction model that was trained with Frenet-transformed training representations of different traffic scenes, wherein the future trajectory of a participant of the traffic scene was known as ground truth for each training representation. Only one Frenet representation was generated for each training representation. A reference path that was as similar as possible to the track sequence of the ground truth was used for the respective Frenet transformation. The reference path was therefore substantially specified here by the regression target to be learned.

According to an example embodiment of the present invention, the AI prediction model generates trajectories as a prediction of the future behavior of a participant in the traffic scene. These trajectories can in principle be output in any coordinate system. The representation of the predicted trajectories is substantially determined by the representation of the ground truth when training the AI prediction model. In the simplest case, the prediction using the AI prediction model provides trajectories in the Frenet coordinate system of the underlying Frenet representation of the traffic scene. This proves to be advantageous, for example, when the observer follows the same trajectory as the observed participant as when driving in line.

In a further development of the method according to an example embodiment of the present invention, the predicted trajectories are transformed into a comparison coordinate system, such as a local Cartesian coordinate system of an observing participant of the traffic scene. If all of the predicted trajectories are represented in the same coordinate system, they can be used more easily in the planning of the trajectory of the observing participant.

According to an example embodiment of the present invention, a computer-implemented system for carrying out the above-described prediction method comprises
a perception layer for aggregating scene-specific information from different sources of information,
an evaluation module for generating a scene representation of the current traffic scene,
a localization module for determining a current position of the participant and a current track section on which the participant is currently located,
a first transformation module for transforming the scene representation into at least one Frenet coordinate system, wherein the current track section specifies at least one section of the respective reference path for the Frenet transformation and
a pretrained AI prediction model that predicts at least one trajectory for the participant based on at least one Frenet representation of the current traffic scene.

The functioning of such a system and advantageous embodiments and further developments of the present invention are explained in more detail in the following in conjunction with the figures.

The present invention also relates to a method for training the AI prediction model of such a system. This involves the use of training representations of different traffic scenes with at least one participant, wherein the future trajectory of the participant is known as ground truth for each training representation. For each training representation, the following steps are carried out:
determining a current position of the participant, a current track section on which the participant is currently located, and at least one track sequence which includes the current track section and a possible continuation of the current track section,
selecting the track sequence that is most similar to the ground truth,
transforming the training representation into a Frenet coordinate system, wherein the selected track sequence specifies the reference path for the Frenet transformation,
using the resulting Frenet representation as an input for the AI prediction model to be trained to predict at least one trajectory,
comparing the at least one predicted trajectory with the ground truth and modifying the AI prediction model as a function of the comparison result.

### BRIEF DESCRIPTION OF THE DRAWINGS

FIG. 1 illustrates the computer-implemented prediction method according to the present invention using a schematic block diagram of a system 100 according to the present invention for predicting trajectories of a participant of a traffic scene.

FIG. 2 illustrates the concept of track sequences used in the context of the present invention.

FIG. 3A to 3D illustrate the method according to the present invention for training an AI prediction model of a system according to the present invention for predicting trajectories of a participant of a traffic scene.

### DETAILED DESCRIPTION OF EXAMPLE EMBODIMENTS

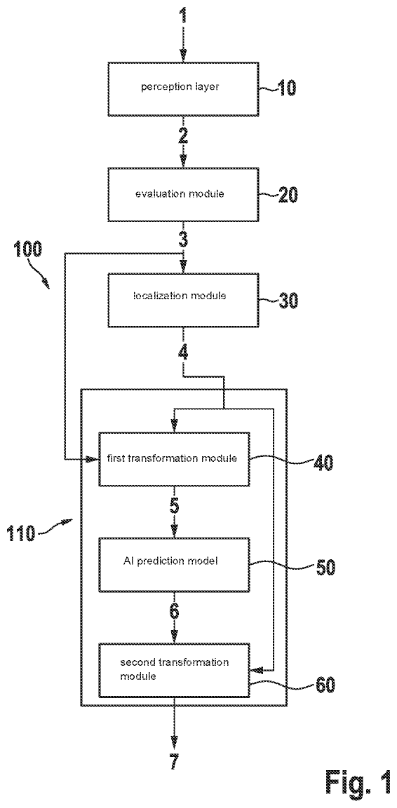

In the embodiment example described here, the system 100 shown in FIG. 1 is assigned to an at least partially automated ego vehicle and is used in the context of trajectory planning for this ego vehicle.

The system 100 includes a perception layer 10 for aggregating scene-specific information from different sources of information. These can be in-vehicle sensors, such as LiDAR sensors, radar sensors and/or RGB cameras installed on the ego vehicle, or non-vehicle sensors, such as LiDAR sensors, radar sensors, and/or RGB cameras installed in or on infrastructure elements. Other possible sources of information include stored map information as well as retrievable weather and road condition information, traffic situation information, etc. The information from the different sources of information is fed to the perception layer 10, which is shown here by the arrow 1. There, this information is typically not only aggregated, but also preprocessed before being forwarded to an evaluation module 20 for extracting relevant scene-specific information (arrow 2). The evaluation typically includes object recognition and object classification. Location and movement parameters of the identified participants in the traffic scene are ascertained. Information about the context, such as the infrastructure situation of the participants within the traffic scene, is obtained as well. As a result of this evaluation, the evaluation module 20 generates a scene representation 3 of the current traffic scene.

The system 100 shown here also includes a separate localization module 30, which could also be part of the evaluation module 20. Based on the scene representation 3, the localization module 30 determines a current position of a participant and a current track section on which the participant is currently located. The localization module 30 moreover determines a plurality of different track sequences as possible route or behavior options for the participant. The localization module 3 passes this information 4 (current position, current track section, and track sequences) to a subsystem 110 of the here-described system 100. In this subsystem 110, at least one trajectory is predicted for each track sequence determined by the localization module 30, i.e., route or behavior option of the participant. For this purpose, the subsystem 110 includes a first transformation module 40 with which the scene representation 3 is transformed into a Frenet coordinate system. The reference path for this transformation is specified on the basis of the respective track sequence. The resulting transformed scene representation 5, also referred to here as a Frenet representation 5, is used as an input for a pretrained AI prediction model 50. This AI prediction model 50 then predicts at least one trajectory 6 for the participant based on the Frenet representation 5. This trajectory 6 is described here in the same Frenet coordinate system as the Frenet representation of the traffic scene on which the prediction is based.

In the embodiment example described here, the subsystem 110 further comprises a second transformation module 60 that communicates with the first transformation module 40, which is illustrated with a double arrow. With the help of this second transformation module 60, the trajectory 6 is transformed back into the initial coordinate system of the scene representation, which serves as the comparison coordinate system for all predicted trajectories. This could be a local Cartesian coordinate system of the ego vehicle, for instance. The resulting back-transformed trajectory is labeled here as 7.

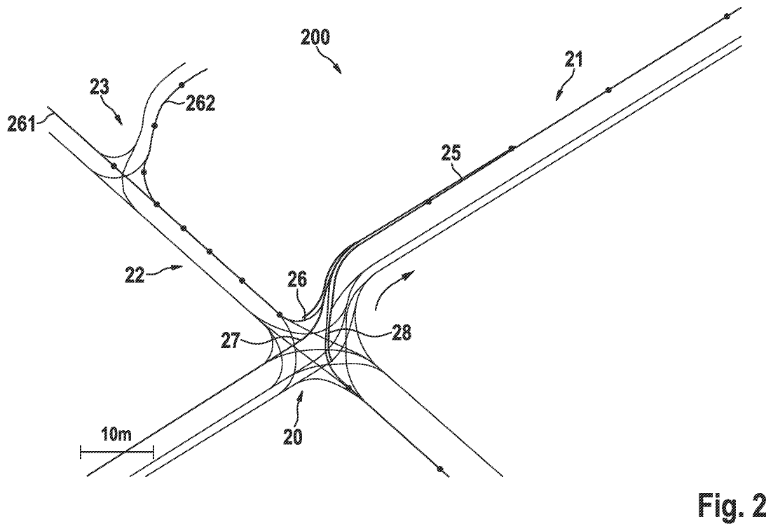

The diagram of FIG. 2 shows example track sequences of a participant in a traffic scene 200. The infrastructure of the traffic scene 200 includes two intersecting roadways 21 and 22, wherein the one roadway 21 runs southwest to northeast, while the other roadway 22 runs northwest to southeast. The roadway 22 also has a branch 23 north of the intersection 20. All roadways 21, 22 and 23 include at least two travel lanes, which is indicated by parallel lane lines. By evaluating scene-specific information, it was possible to ascertain that a participant is in a lane of the roadway 21 and is approaching the intersection 20 from the northeast (line 25). The track sequences 26, 27 and 28 were determined for the possible route options “turn right”, “go straight” and “turn left”. The route option “turn right” could also be split in accordance with the track sequences 261 and 262.

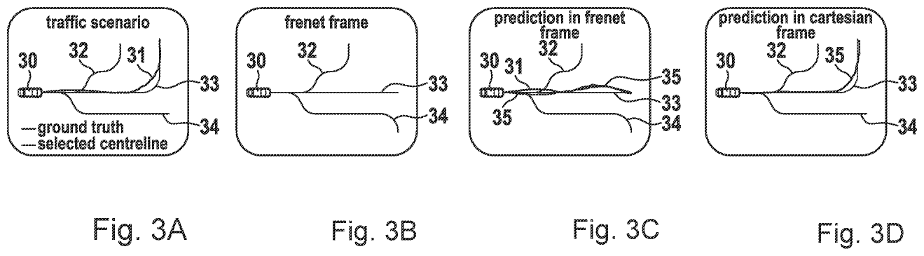

The method according to the present invention for training an AI prediction model, which can advantageously be used in the context of the above-described system 100, is explained in the following with reference to FIGS. 3A to 3D. Training representations of different traffic scenes with at least one participant are used for training. For each training representation, the future trajectory of the participant is known as ground truth. Such a training scenario with a participant 30 and the ground truth 31 is shown in FIG. 3A; specifically in a Cartesian coordinate system.

For each training representation, a current position of the participant and a current track section are first determined. Based on this, at least one track sequence is then determined as the route option for the participant. Three different track sequences 32, 33 and 34, each represented here by its centerline, were determined for the training scenario shown in FIG. 3A. Of these three track sequences 32, 33 and 34, the track sequence that is most similar to the ground truth 31 was selected; here the track sequence 33.

The training representation was then transformed into a Frenet coordinate system, which is shown in FIG. 3B. The centerline of the track sequence 33 that is most similar to the ground truth 31 was used as the reference path for this Frenet transformation. The track sequence 33 is therefore shown here as a straight line, whereas the track sequence 34 bends in its further progression in the Frenet representation. The track sequence 32 remains largely unchanged.

In the embodiment example described here, the AI prediction model is intended to predict trajectories in Frenet representation. Therefore, the trajectories provided by the AI prediction model during the training phase are compared with the respective ground truth in Frenet representation. According to the present invention, only the Frenet representation of the training scenario that was ascertained for the track sequence 33 is used as an input for the AI prediction model to be trained, because the track sequence 33 is most similar to the ground truth 31. The resulting trajectory 35 is shown in the Frenet representation of FIG. 3C. together with the ground truth 31.

The AI prediction model is then modified as a function of a comparison between the predicted trajectory 35 and the ground truth 31 until a predefined quality criterion is met.

FIG. 3D shows the training scenario together with the predicted trajectory 35 after the back transformation into a Cartesian coordinate system.

What is claimed is:

1. A computer-implemented method for predicting at least one trajectory of at least one participant of a traffic scene, the method comprising the following steps:
generating a scene representation of the traffic scene based on aggregated scene-specific information;
predicting at least one trajectory for the at least one participant based on the scene representation using a pretrained AI prediction model;
determining a current position of the participant and a current track section on which the participant is currently located;
transforming the scene representation into at least one Frenet coordinate system to provide at least one resulting Frenet representation of the traffic scene, wherein the current track section specifies at least one section of a respective reference path for the Frenet transformation;
wherein the prediction is based on the at least one resulting Frenet representation of the traffic scene.

2. The method according to claim 1, wherein at least one track sequence is determined, wherein the at least one track sequence includes the current track section and a possible continuation of the current track section, and the at least one track sequence specifies the reference path for the Frenet transformation of the scene representation.

3. The method according to claim 2, wherein the current position and/or the current track and/or the at least one track sequence of the participant is determined based on acquired sensor data and map information.

4. The method according to claim 2, wherein at least two different track sequences are determined, the scene representation is transformed into at least two different Frenet coordinate systems, wherein one of the at least two different track sequences specifies the reference path for the respective Frenet transformation, and the pretrained AI prediction model is used for the prediction for all resulting Frenet representations of the traffic scene.

5. The method according to claim 2, wherein the AI prediction model is an AI prediction model trained with Frenet-transformed training representations of different traffic scenes with at least one participant, wherein, for each of the training representation, a future trajectory of the participant was known as ground truth, and wherein a track sequence that was as similar as possible to the ground truth was used in each case as the reference path for the Frenet transformation of the training representations.

6. The method according to claim 1, wherein the prediction using the AI prediction model provides trajectories in the Frenet coordinate system of the Frenet representation of the traffic scene.

7. The method according to claim 1, wherein the predicted trajectory is transformed into a comparison coordinate system, the comparison coordinate system including a local Cartesian coordinate system of an observing participant of the traffic scene.

8. A computer-implemented system configured to predict at least one trajectory of at least one participant of a traffic scene, the system comprising:
a. a perception layer configured to aggregate scene-specific information from different sources of information;
b. an evaluation module configured to generate a scene representation of a current traffic scene;
c. a localization module configured to determine a current position of the participant and a current track section on which the participant is currently located;
d. a first transformation module configured to transform the scene representation into at least one Frenet coordinate system to provide at least one Frenet representation of the current traffic scene, wherein the current track section specifies at least one section of a respective reference path for the Frenet transformation; and
e. a pretrained AI prediction model configured to predict at least one trajectory for the participant based on the at least one Frenet representation of the current traffic scene.

9. The system according to claim 8, wherein the localization module is configured to determine at least one track sequence, wherein the track sequence includes the current track section and a possible continuation of the current track section, so that the first transformation module can determine the reference path for the Frenet transformation of the scene representation based on the track sequence.

10. The system according to claim 8, further comprising:
a second transformation module configured to transform the at least one predicted trajectory into a comparison coordinate system including a local Cartesian coordinate system of an observing participant of the traffic scene.

11. A method for training an AI prediction model of a system configured to predict at least one trajectory of at least one participant of a traffic scene, in which training representations of different traffic scenes with at least one participant are used, wherein a future trajectory of the participant is known as ground truth for each training representation, the method comprising the following steps for each of the training representations:
a. determining a current position of the participant, a current track section on which the participant is currently located, and at least one track sequence which includes the current track section and a possible continuation of the current track section;
b. selecting the track sequence that is most similar to the ground truth;
c. transforming the training representation into a Frenet coordinate system to provide a resulting Frenet representation, wherein the selected track sequence specifies the reference path for the Frenet transformation,
d. using the resulting Frenet representation as an input for the AI prediction model to be trained to predict at least one trajectory; and
e. comparing the at least one predicted trajectory with the ground truth and modifying the AI prediction model as a function of a result of the comparison.
